(19) United States
(12) Patent Application Publication
(10) Pub. No.: US 2023/0193175 A1
(43) Pub. Date: Jun. 22, 2023

(54) Microorganism Compatible Alcoholic Kombucha Flavorings

(71) Applicant: Sergio Mora, San Diego, CA (US)

(72) Inventor: Sergio Mora, San Diego, CA (US)

(21) Appl. No.: 17/915,454

(22) PCT Filed: Mar. 29, 2021
(86) PCT No.: PCT/US21/24746

§ 371 Date: Sep. 28, 2022

Related U.S. Application Data
(60) Provisional application No. 63/001,346, filed on Mar. 29, 2020.

(51) Int. Cl. C12G 3/08; C12C 11/11

(52) U.S. Cl. CPC C12G 3/08; C12C 11/11

(57) ABSTRACT

Novel natural flavoring compounds that are compatible with live kombucha microorganisms during fermentation and storage. The unexpected discovery of a number of desirable flavors is disclosed. In a preferred embodiment, it was found that blueberry results in a very desirable refreshing alcoholic beverage with great taste and aroma.

### CROSS REFERENCE TO RELATED APPLICATIONS

This application claims priority to and the benefit of U.S. Provisional Patent Application No. 63/001,346 filed on Mar. 29, 2020, the entire contents of which is incorporated by reference herein.

### BACKGROUND OF THE INVENTION

Kombucha (also tea mushroom, tea fungus, or Manchurian mushroom when referring to the culture; botanical name Medusomyces gisevii) is a fermented, slightly alcoholic, lightly effervescent, sweetened black or green tea drink commonly consumed for its supposed health benefits. Sometimes the beverage is called kombucha tea to distinguish it from the culture of bacteria and yeast. Juice, spices, fruit or other flavorings are often added to enhance the taste of the beverage.

Kombucha is thought to have originated in Manchuria, China where the drink is traditionally consumed, or in Russia and Eastern Europe. Kombucha is now homebrewed globally, and also bottled and sold commercially by various companies.

Kombucha is produced by fermenting sugared tea using a symbiotic culture of acetic acid bacteria (AAB: Komagatacibacter, Gluconobacter, and Acetobacter species), lactic acid bacteria (LAB: Lactobacillus, Lactococcus) and yeasts (Schizosaccharomyces pombe, Saccharomycodes ludwigii, Kloeckera apiculata, Saccharomyces cerevisiae, Zygosaccharomyces bailii, Torulaspora delbrueckii, Brettanomyces bruxellensis), i.e. the microbial spectrum of Kombucha consortium referred to as “SCOBY” (Villarreal-Soto SA et al., (2018), J Food Sci, 83(3):580-8) or commonly called a “mother” or “mushroom”.

The microbial populations in a SCOBY vary; the yeast component generally includes Saccharomyces cerevisiae, along with other species; the bacterial component almost always includes Gluconacetobacter xylinus to oxidize yeast-produced alcohols to acetic acid (and other acids, such as gluconic, tartaric, malic and in less proportion, citric acids). Although the SCOBY is commonly called “tea fungus” or “mushroom”, it is actually “a symbiotic growth of acetic acid bacteria and osmophilic yeast species in a zoogloeal mat [biofilm, usually formed by the synthesis of microbial cellulose] (due to the activity of certain strains of AAB).” The living bacteria are said to be probiotic, one of the reasons for the popularity of the drink.

The bacteria and yeasts present in the medium create a powerful symbiosis capable of inhibiting the growth of contaminating microorganisms. The different yeasts and bacteria species act in parallel, producing two different final products: a floating biofilm and a sour liquid phase comprising fermented tea. At the beginning of the fermentation process, the yeast hydrolyzes sucrose into glucose and fructose, formerly the ethanol is produced and finally the AAB transform ethanol into acetic acid (FIG. 1). Acetic acid, gluconic acid, and ethanol are the main components in the liquid, but also in the biofilm due to its great water absorption capacity. Under aerobic conditions, the symbiotic consortium of kombucha is able to covert sugar and tea in a period from 7 to 10 days into a lightly, carbonated, slightly sour and refreshing drink comprising several acids, 14 amino acids, vitamins and some hydrolytic enzymes (Malbaŝa RV et al., (2011), Food Chem, 127(4):1727-31.

The composition and metabolite concentration of kombucha are dependent upon the inoculum source, the sugar and tea concentration, the fermentation time, the pH and the temperature used. Any changes in the fermentation conditions may affect the final product. The main components, and some key metabolites produces in the fermented tea, are listed in FIG. 2. Among the main components of kombucha tea, glucuronic acid is considered to be the main therapeutic agent. (Kumar V and Joshi V K, (2016), Intl J Food Ferment Technol, 6(1):13).

Numerous health benefits have been attributed to drinking kombucha. These include claims for treating, aging, anorexia, arthritis, atherosclerosis, cancer, constipation, and diabetes. FIG. 3 lists various in vitro biological activities that have been reported in the literature. No systematic clinical trials, however, have been conducted to validate these claims although there have been numerous publications implicating its efficacy.

Fermented kombucha drinks, however, have a low pH which is acidic (due to the aforementioned acids) causing the drinks to have a sour flavor. Many kombucha producers add natural fruits and/or synthetic flavors to mask the sour taste. Many of the natural fruits and synthetic flavors, however, are metabolized by the living microorganisms and are degraded resulting in off-flavors and unpleasant aromas, or any added flavor are lost or diminished during the fermentation process and/or while the kombucha is stored for future consumption. In addition, natural fruits contain microorganisms that interfere with the fermentation process. There is a need, therefore, for flavored kombucha beverages that appeal to consumers so that they might benefit from the many numerous health benefits provided by kombucha, as reported in the literature.

The unexpected discoveries in the present invention results in a very flavorful, desirable alcoholic beverage with little or no perception of a sour taste.

### BRIEF DESCRIPTION OF THE INVENTION

A method of flavoring kombucha with specific natural flavoring compounds that are compatible with the live microorganisms, such as bacteria and yeast, used during the fermentation process used to produce kombucha as well as while the brewed kombucha is being stored for future consumption. The unexpected discovery of a number of desirable flavors is disclosed.

### BRIEF DESCRIPTION OF THE SEVERAL VIEWS OF THE DRAWINGS

The renderings and images are included for illustrative and interpretive purposes relative to specific embodiments and applications and should not be construed as the sole positioning, configurations, or singular use of the present invention. These embodiments are described in sufficient detail to enable those skilled in the art to practice the invention. Other embodiments may be utilized, and structural and logical changes may be made, without departing from the scope of the present invention.

FIG. 1 depicts the main metabolic activity of kombucha tea as a flow chart;

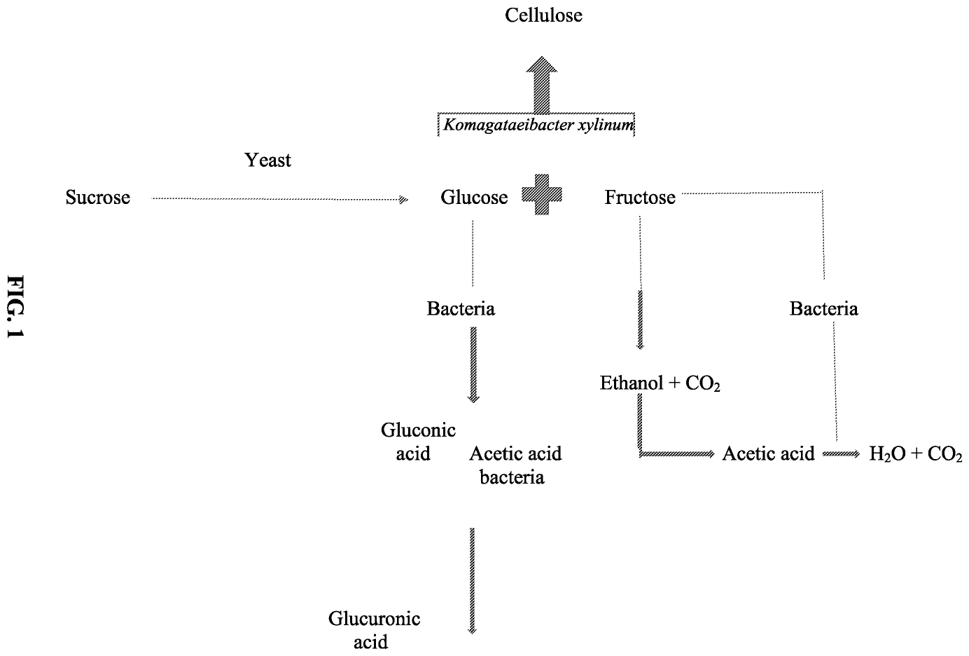

FIG. 2 is a table of the general chemical composition of kombucha tea;

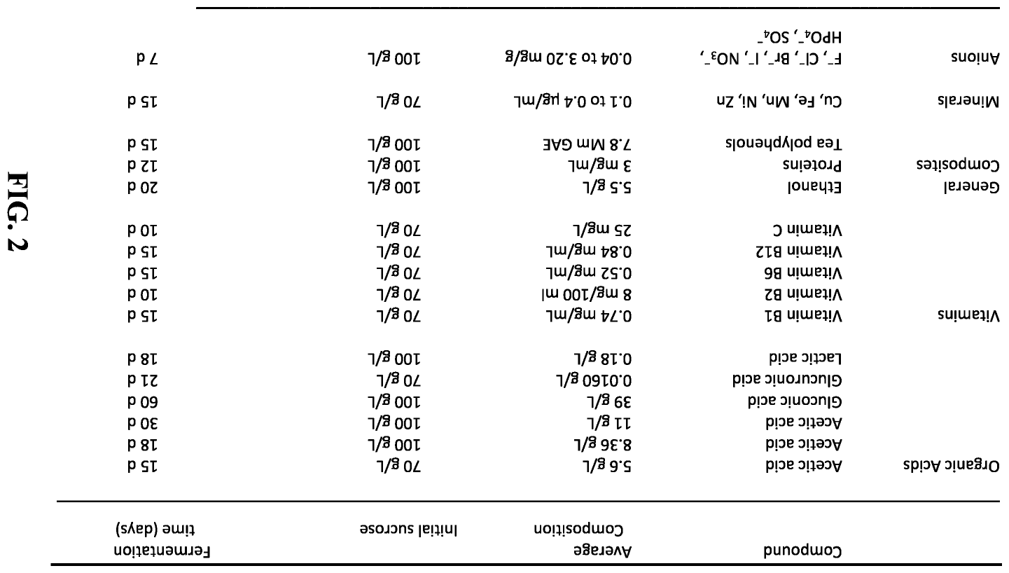

FIG. 3 is a table of the reported in vitro activities of kombucha tea; and

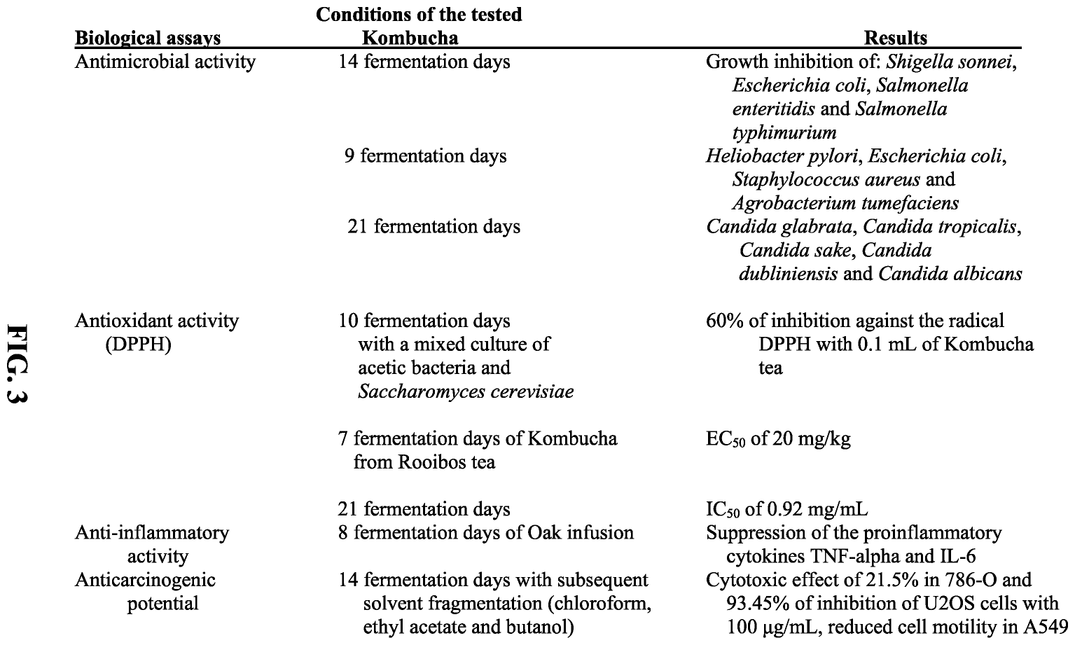

FIG. 4 is a table reporting the selected flavoring agents tested in a prepared kombucha tea and the observed results.

### DETAILED DESCRIPTION OF THE PRESENT INVENTION

The materials, methods, and examples are illustrative only, and are not intended to be limiting. In the following detailed description, numerous specific details are provided, such as the identification of various system components, to provide an understanding of embodiments of the invention. One skilled in the art will recognize, however, that embodiments of the invention can be practiced without one or more of the specific details, or with other methods, components, materials, etc. In still other instances, well-known structures, materials, or operations are not shown or described in detail to avoid obscuring aspects of various embodiments of the invention.

Kombucha can be prepared at home or commercially. Kombucha is made by dissolving sugar (preferably, granulated sugar (https://www.webstaurantstore.com/23/bulk-sugar.html?filter=sugar-type:granulated-sugar) (although organic juice crystals and raw or whole cane sugar may be used, it is recommended, however, that brown sugar, honey, agave, maple coconut sugar, palm sugar, powdered sugar or sugar-free substitutes not be used) in non-chlorinated boiling water (between 60-85° F., preferably between 75-80° F.), in a sterilized, glass container (https://www.bottlestore.com/industry-container-catalog/food-and-beverage/homebrew-beer-making-glass-bottles-jugs.html). A combination of a natural, organic substance, such as vinegar in combination with boiling water, is preferred to sterilize the container. Antibacterial soap should not be used as it may deactivate or actually kill the bacteria needed to produce the SCOBY. It is not recommended to contact the contents of the brewing container with metal or plastic.

Tea leaves (Monterey Bay Spice Company, Watsonville, Calif.), preferably black tea leaves, such as Ceylon and English Breakfast, but other types are tea may be used, are steeped in the hot sugar water and discarded. Herbal tea is not suitable for use as it does not contain the nutrients needed for fermentation. Generally, the ratio of water to sugar to tea is 7 cups of water to ½ cup sugar to 4 bags of tea (Bond S, (2020), The Comprehensive Guide to Kickass Kombucha, Live Eat Learn (Publ), www.liveeatlearn.com, (49 pages)). The sweetened tea is cooled, and the SCOBY culture, preferably unflavored SCOBY (Whole Foods, Austin, Tex.), is added. The SCOBY may also be obtained from a previous kombucha. Using the 7½:4, ratio approximately 1 cup of kombucha is used. The mixture is then poured into a sterilized, glass container along with previously fermented kombucha tea to lower the pH. The container is covered with a breathable fabric to prevent insects such as fruit flies, debris and airborne spores of bacteria or fungus, from contaminating the kombucha. The Inventor discovered that the addition of ginger (primarily ginger beer) and fennel during the fermentation process improved the quality of the tea. Fennel, in particular, improved the aroma resulting in a better tasting tea. The pectin found in ginger root facilitates introduces new microorganisms to the brew.

The tea is left to ferment, aerobically, for a period of up to 10 to 14 days at room temperature (18 ° C. to 26 ° C.). Kombucha should not be brewed in direct sunlight. A new “daughter” SCOBY will form on the surface of the tea to the diameter of the container. After fermentation is completed, the SCOBY is removed and stored along with a small amount of the newly fermented tea. The remaining kombucha is strained and bottled for a secondary fermentation for a few days or stored at a temperature of 4° C. and not in direct sunlight.

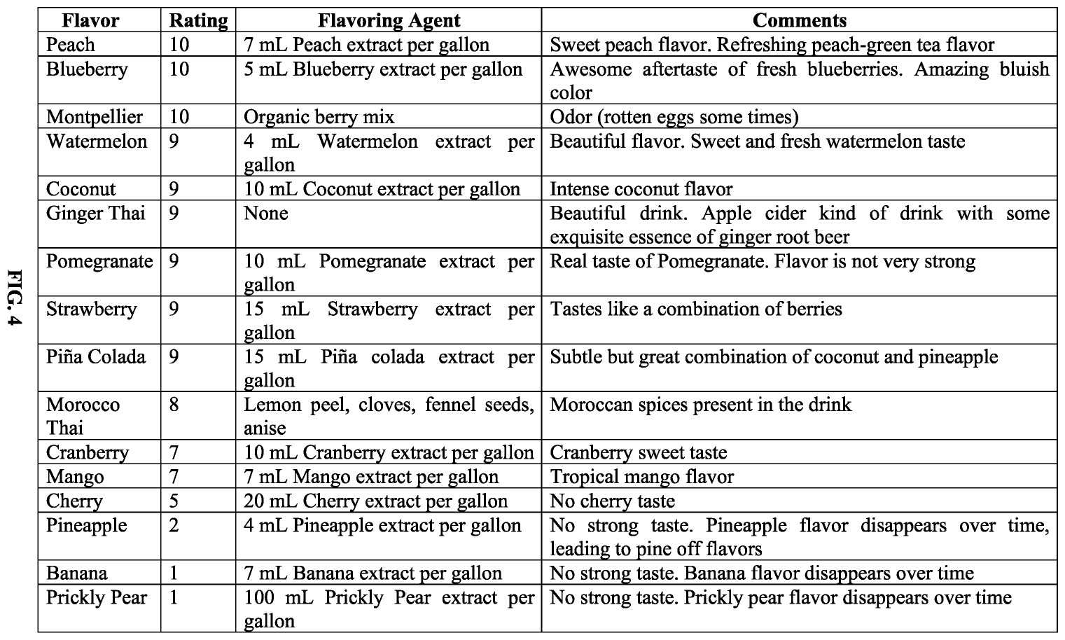

According to the preferred embodiment of the instant invention, the fermented tea is then combined in a ratio of approximately 1 part combination of Thai tea (Pantai Tea (Amazon, Inc., Seattle, Wash.)) and black tea (Orange Picot tea (Walmart, Inc. (Betonville, Ariz.)) to 9 parts of Gnome-B45 yeast (Imperial Yeast, Portland, Oreg.), sugar (https://www.webstaurantstore.com/23/bulk-sugar.html?filter=sugar-type:granulated-sugar) and water (the “master batch”) and fermented anaerobically, until the alcohol content is raised above 5% by volume and preferably over 7%. After fermentation is complete, the master batch is combined with various, natural flavorings (Olivenation, Avon, Mass.), packaged in sterilized kegs, bottles or cans, using known filling techniques, for subsequent distribution and consumption. During the research and development of the claimed invention, it was found that not all flavors are compatible with the fermented kombucha microorganisms resulting in undesirable off flavors and odors that made the beverage undrinkable. Therefore, a systematic study was undertaken to discover which flavors were compatible with the alcoholic kombucha microorganisms during storage and distribution of the product. The results of the experimentation are summarized in FIG. 4.

FIG. 4 summarizes the results of the experimentation and feedback from focus group studies carried out by the Inventor. The flavors are tabulated in the first column. A rating scale was determined by the focus group studies from a 1 to 10 scale with 1 being bad and 10 exceptional. From the results reported in FIG. 4, some flavors were well-liked, while other flavors were not. Based on the results, only flavors with a score of 8 or higher were utilized as commercially acceptable beverages.

The examples and illustrations included herein show, by way of illustration and not of limitation, specific embodiments in which the subject matter may be practiced. As mentioned, other embodiments may be utilized and derived therefrom, such that structural and logical substitutions and changes may be made without departing from the scope of this disclosure. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of providing kombucha microorganism compatible flavors for the production of high alcohol content fermented tea beverages.

2. The method according to claim 1, wherein the fermented tea beverages are prepared using a first, aerobic fermentation process and a second, anaerobic fermentation process.

3. The method according to claim 2, wherein the first, aerobic fermentation process includes adding ginger and fennel during the fermenting process.

4. The method according to claim 3, wherein the source of the ginger is ginger beer.

5. The method according to claim 2, wherein the second fermentation process utilizes fermented tea combined with brewer's yeast in a ratio of 1 part tea to 9 parts yeast.

6. The method according to claim 5, wherein the yeast is Gnome-B45 yeast.

7. The method according to claim 2, wherein water is used in the fermentation process.

8. The method according to claim 2, wherein the second fermentation process is concluded when the alcohol content of the tea beverage is between 5% by volume to over 7% by volume.

9. The method according to claim 8, wherein 7 ml of peach extract per gallon of tea beverage is added during the fermentation process.

10. The method according to claim 8, wherein 5 ml of blueberry extract per gallon of tea beverage is added during the fermentation process.

11. The method according to claim 8, wherein 4 ml of watermelon extract per gallon of tea beverage is added during the fermentation process.

12. The method according to claim 8, wherein 7 ml of peach extract per gallon of tea beverage is added during the fermentation process.

13. The method according to claim 8, wherein 10 ml of coconut extract per gallon of tea beverage is added during the fermentation process.

14. The method according to claim 8, wherein 10 ml of pomegranate extract per gallon of tea beverage is added during the fermentation process.

15. The method according to claim 8, wherein 15 ml of strawberry extract per gallon of tea beverage is added during the fermentation process.

16. The method according to claim 8, wherein 15 ml of piña colada extract per gallon of tea beverage is added during the fermentation process.

17. The method according to claim 8, wherein 10 ml of cranberry extract per gallon of tea beverage is added during the fermentation process.

18. The method according to claim 8, wherein 7 ml of mango extract per gallon of tea beverage is added during the fermentation process.
